(19) United States
(12) Patent Application Publication
(10) Pub. No.: US 2012/0181728 A1
(43) Pub. Date: Jul. 19, 2012

(54) INJECTION MOLDING NOZZLE

(75) Inventor: Scott Greb, Washington Township, MI (US)

(73) Assignee: Incoe Corporation, Troy, MI (US)

(21) Appl. No.: 13/384,992

(22) PCT Filed: Jul. 23, 2010
(86) PCT No.: PCT/US10/43105

§ 371 Date: Mar. 27, 2012

Related U.S. Application Data
(60) Provisional application No. 61/227,904, filed on Jul. 23, 2009.

(51) Int. Cl. B29C 45/74; B29C 45/20

(52) U.S. Cl. 264/328.15; 425/569; 425/549

(57) ABSTRACT

An injection molding nozzle for dispensing of molten material includes an elongated body member having an outer surface, a first portion at a proximal end, a second portion at a distal end, and a central passageway extending longitudinally therethrough from the first portion to the second portion. The central passageway includes an inlet defined at the proximal end and splits outwardly at the second portion to form a radially extending passageway leading to an outlet. A tip member is coupled to the outlet to facilitate dispensing of molten material into a mold cavity. A groove is defined on the outer surface of the body member that winds from the first portion to a heated section of the second portion that is positioned adjacent to the tip member.

### CROSS-REFERENCE TO RELATED APPLICATION

This application claims the benefit of U.S. Provisional Patent Applications No. 61/227,904, filed Jul. 23, 2009, the disclosure of which is incorporated herein by reference in its entirety.

### BACKGROUND

The present disclosure relates generally to plastic injection molding systems for injecting plastic material into mold cavities. More specifically, the present disclosure relates to a heated edge gated injection molding nozzle and a method of using the same.

### DESCRIPTION OF THE RELATED ART

There are a number of known injection molding machines and systems. The injection molding machine melts a material and then injects the molten material through a machine nozzle into a mold cavity. Typically, the injection molding machine nozzle includes a heating element, such as to provide heat to maintain the temperature of the melted material within the acceptable range. Known heated injection molding machine nozzles heat the material inefficiently and non-uniformly, and they do not maintain the temperature and consistency of the melted material throughout the nozzle, and especially at the outer end of the nozzle.

Accordingly, there is a need in the art for an injection molding nozzle and method of use suitable for achieving a more uniform temperature profile throughout the nozzle.

### SUMMARY

The present disclosure provides for an injection molding nozzle for dispensing of molten material including an elongated body member having an outer surface, a first portion at a proximal end, a second portion at a distal end, and a central passageway extending longitudinally therethrough from the first portion to the second portion. The central passageway includes an inlet defined at the proximal end and splitting outwardly at the second portion to form a radially extending passageway leading to a corresponding outlet. A tip member is coupled to the outlet and is adapted to facilitate dispensing of molten material into a mold cavity. A groove is defined on the outer surface of the body member that winds from the a heated section of the first portion to a heated section of the second portion that is positioned adjacent the tip members. An electrically insulated heating element is positioned within the groove and is adapted to maintain the molten material within a predetermined temperature range throughout the nozzle, including the heated section of the second portion.

One advantage of the present disclosure is that the injection molding nozzle maintains the temperature of the melted material at the outermost end of the nozzle adjacent the edge gate. Another advantage of the present disclosure is that the injection molding nozzle heats the melt more efficiently and uniformly. Still another advantage of the present disclosure is that the injection molding nozzle has a one-piece body construction that mitigates leakage of melt material. A further advantage of the present disclosure is that the injection molding nozzle assembly has a simple design for easy assembly. Still a further advantage of the present disclosure is that a method of assembling and using the injection molding nozzle in an injection molding machine is provided.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of an injection molding nozzle, according to an exemplary embodiment;

FIG. 2 is a top view of the injection molding nozzle of FIG. 1, according to an exemplary embodiment;

FIG. 3 is a cross-sectional view of the injection molding nozzle of FIG. 2 taken along the 3-3 line, according to an exemplary embodiment;

FIG. 4 is a side view of the injection molding nozzle of FIG. 1;

FIGS. 5 is a perspective view of an injection molding nozzle, according to a further exemplary embodiment;

FIG. 6 is a cross-sectional view of the injection molding nozzle of FIG. 5, according to an exemplary embodiment;

FIG. 7 is a side view of the injection molding nozzle of FIG. 5;

FIG. 8 is a perspective view of an injection molding nozzle, according to an even further exemplary embodiment;

FIG. 9 illustrates an example mold apparatus having a molding nozzle of FIG. 1 positioned therein;

FIG. 10 illustrates the mold apparatus of FIG. 9 with an insert tool and manifold coupled to the nozzle; and

FIG. 11 illustrates an example mold apparatus with multiple nozzles of FIG. 5 positioned therein.

### DETAILED DESCRIPTION

The present disclosure provides for an injection molding machine, particularly one that is used in molding or fabrication of items or parts. The machine includes a housing having a mold cavity that generally conforms to the shape of the item or part being molded. The mold includes an opening that is continuous with the mold cavity for receiving a nozzle 10 in a manner to be described.

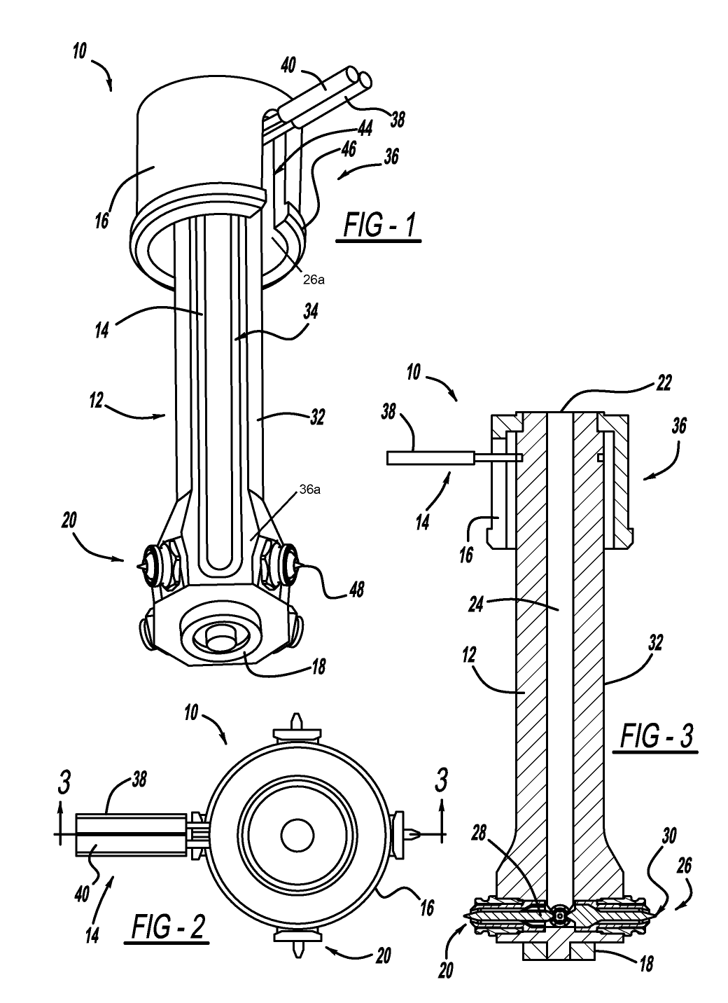

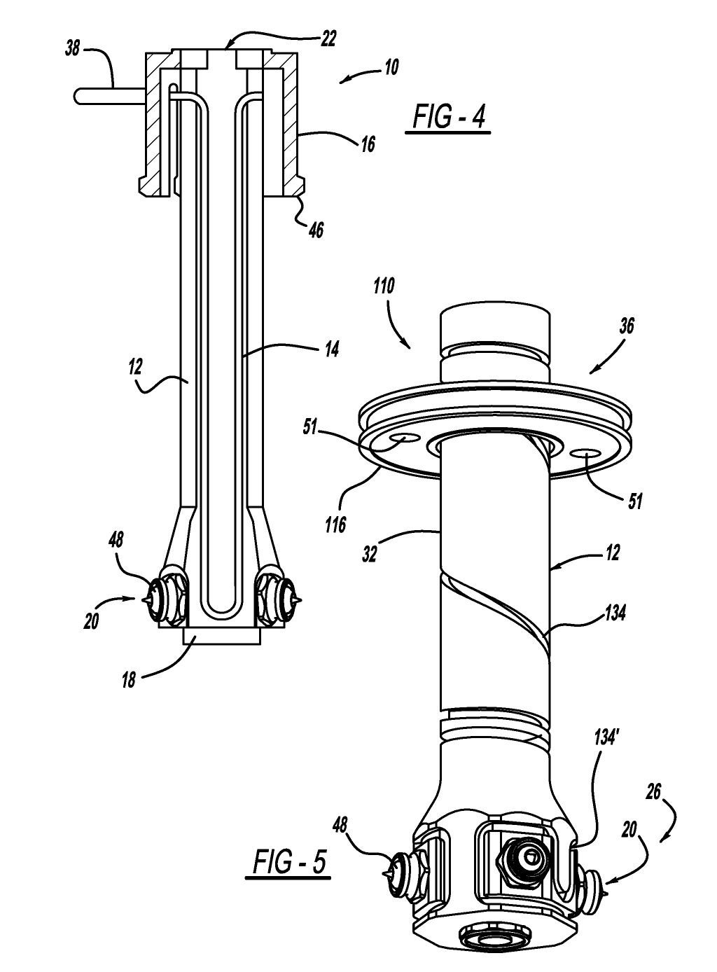

Referring to FIGS. 1-4, an injection molding nozzle 10 for injecting material into a mold associated with an injection molding machine is shown. An example of a material is a molten material, such as a polymer or plastic or the like. In an example, the injection molding nozzle 10 defines a generally cylindrical profile and includes a one-piece body or shank member 12, a heating element 14, a guide collar 16, a base 18, and a plurality of tip members 20.

The body or shank 12 is a generally elongated member, such as tubular, and includes an inlet 22 at proximal end of the nozzle for receiving the molten material to be infused into a central passageway 24 and dispensing the heated material out through a tip member 20 adjacent the base 18 at a distal end of the nozzle. Body 12 includes a first portion 26 and a second portion 36. In this example, first portion 26 can be referred to as an “upper” portion and second portion 36 can be referred to as a “lower portion”. This example illustrates a vertical orientation for nozzle 10 with first portion 26 being an upper portion and second portion 36 being a lower portion, although alternative orientations are within the scope of the present disclosure.

The central passageway 24 extends longitudinally from the inlet 22 towards the second portion 36 of the injection molding nozzle 10 and splits/branches outwardly into a radial passageway 28 which leads to an outlet 30 for delivering molten material into the mold cavity. In an example, the outlet is formed perpendicular to the axis of the elongated body 12. An outer surface 32 of the body or shank 12 also includes a groove 34 formed into the outer surface 32 thereon in a predetermined manner, such as machined, etched, carved, etc. In this example, the groove 34 extends in a longitudinal direction from the first portion 26 of the injection molding nozzle 10 to the second portion 26 of the injection molding nozzle 10. Also in this example, the groove 34 returns back up to the upper portion 36 of the injection molding nozzle 10, and generally forms a loop-like pattern or a “U-shaped” geometry. The “U-portion” of the groove is formed between and adjacent to the tip members 20. Other patterns for the groove may also be formed in the body.

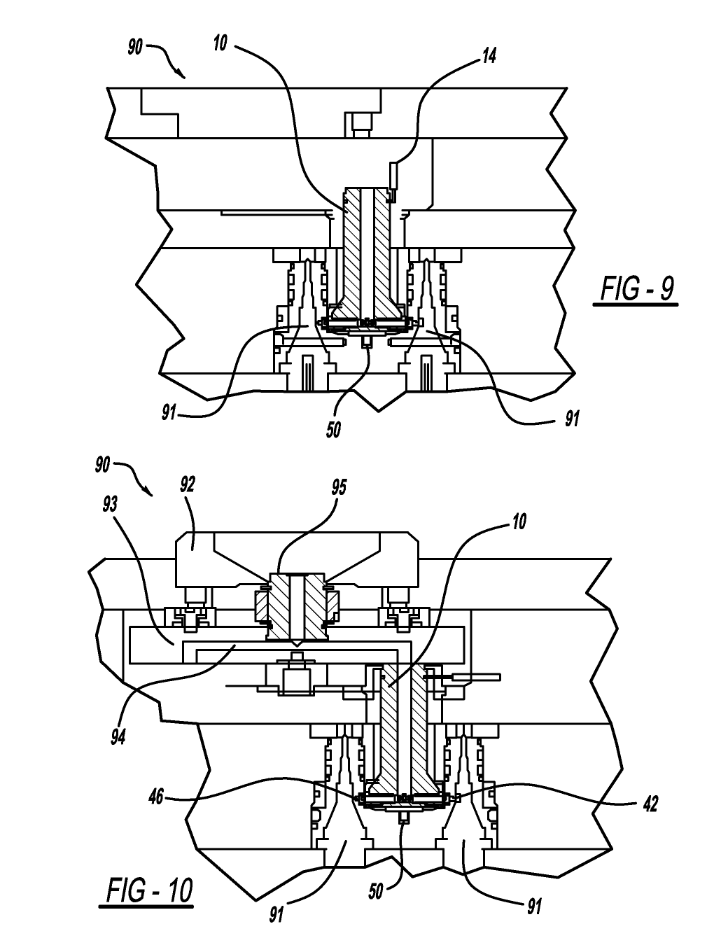

The injection molding nozzle 10 includes an electrically insulated heating element 14 that is adapted to maintain the molten material within a desired temperature range. The electrical heating element 14 can include one continuous integral piece of conductive material (e.g., metal, etc.) having a first and second end (terminals) 38, 40. The conductive material may have a generally tubular shape. The heating element 14 fits within the groove 34 such that the heating element 14 winds from the first portion 26 of the injection molding nozzle 10 toward the second portion 36 of the injection molding nozzle 10 and loops back toward the first portion 26 of the injection molding nozzle 10. A heated section 36a is defined in the second portion 36 of the nozzle 10 that provides suitable heat to a distal area of the body 12. The first portion of the nozzle 10 may also includes a heated section 26a. The further the molten travels through the nozzle, the more heat loss is experienced. At the second portion 36 of the injection molding nozzle 10, the heating element 14 winds adjacent to the edge gate 42 (shown in FIGS. 9-10), outlets 30, and tip member 20 and almost to the base 18 in one embodiment, to thereby heat the material more efficiently and uniformly, and maintain the temperature of the material throughout the nozzle 10 and the heated section 36a of the second portion 36, including at the distal end of the nozzle 10.

Undesired heat loss occurs in the first section and again in the second section as molten material travels from the inlet 22 to the outlet 30. The groove 34 with heating element 14 positioned therein reduces heat loss by heating the first section 26a and second section 36b. Therefore, the molten material can be maintained within a desired temperature range across the entire length of the nozzle 10. Accordingly, the heating element 14 reduces undesired heat loss or heat sink near the outlets 30 of the nozzle 10 or towards the distal end of the nozzle 10 at the second section of the body 12. The heating element 14 may have a predetermined dimensions, such as, a diameter of 1.5 mm. The heating element 14 may generate any needed and/or desired heat. For example, the heating element 14 may have a temperature range of 200° F. to 800° F., depending on the molten material (e.g., plastic, etc.) being used. An example of a heating element 14 is a chrome nickel resistance wire extending centrally through a refractory powder electrical insulating material such as magnesium oxide inside a steel casing having a protective nickel coating.

The injection molding nozzle 10 also includes a guide collar 16 having a generally hollow cylindrical shape and rests atop the first portion 26 of the injection molding nozzle 10. The guide collar 16 guides and locates the injection molding nozzle 10 into the cavity in the mold. The guide collar 16 also provides an insulated space between the heated nozzle 10 and surrounding cooled mold. The guide collar 16 can further include a cutout or slot 44 extending upward from the base 46 of the guide collar 16 for each end 38, 40 of the heating element 14 to protrude therefrom.

The injection molding nozzle 10 includes a tip member positioned thereon. The injection molding nozzle may include one tip member 20 or a plurality of tip members 20 spaced circumferentially around the perimeter of the second portion 36 of the body 12. The tip member 20 can include an insert 48 made from a high heat conductive material (e.g., copper alloy, etc.) to facilitate the injection of molten material into the cavity. In this example, insert 48 is conically shaped to facilitate molten material distribution.

The base portion 18 of the injection molding nozzle 10 may provide support for the nozzle when installed in the mold. In this example, the base portion 18 is generally circular in shape and can be threaded to receive a support 50 (shown in FIGS. 9-11) for supporting the nozzle 10 in the mold cavity. The base portion 18 secures and stabilizes the injection molding nozzle 10 in place within the mold. An example of an injection molding nozzle support 50 is a cylindrical member, although other shapes are contemplated.

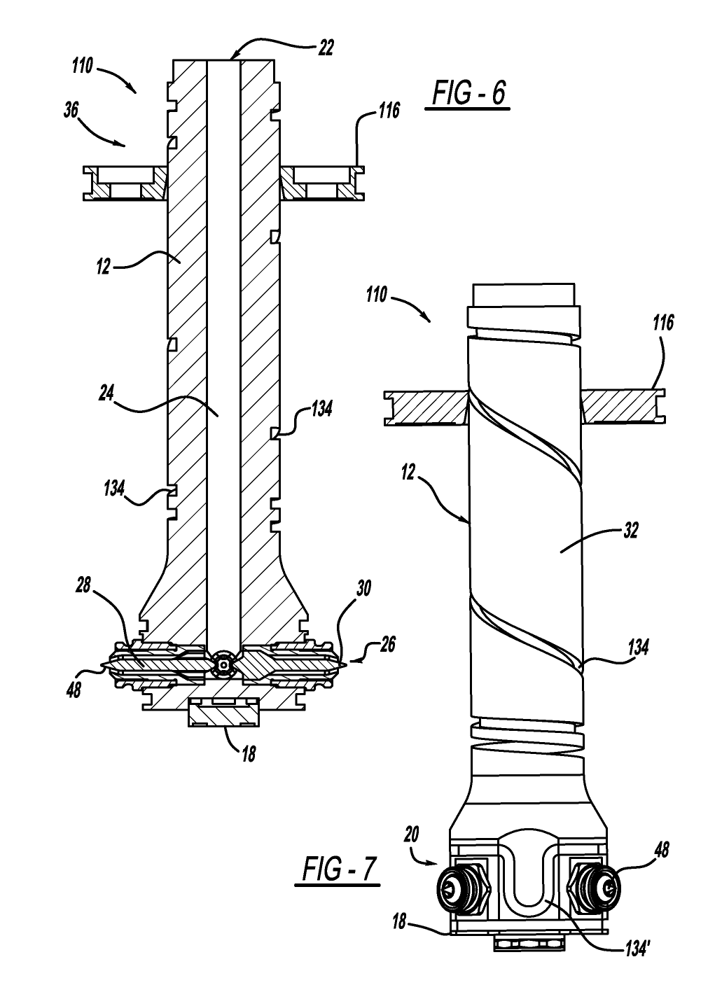

FIGS. 5-7 illustrate a further example of a nozzle 110. Like parts are shown having like numerals to those of FIGS. 1-4 increased by 100. Nozzle 110 includes a generally cylindrical body 12 having an outer surface 32. In this example, guide collar 116 is positioned near first section 26 and is substantially ring shaped having a mounting hole 51 to securely mount within a mold. FIG. 5 illustrates a guide collar 116 having two holes 51 spaced apart opposite each other for more even mounting. A helically-shaped groove 134 is defined around outer surface 32 extending from first section 26 to second section 36. In this example, the groove 134 inclines and wraps around the outer surface 32. At second section 36, the groove 134 wraps around outer surface 32 at a more shallow incline to form a tighter wrap for the heating element. Accordingly, this allows for a variant in heat distribution from first section 26 to second section 36. The groove 134 extends in a non-conventional geometry into the second section, where it extends around the tip member 20 as shown at 134′.

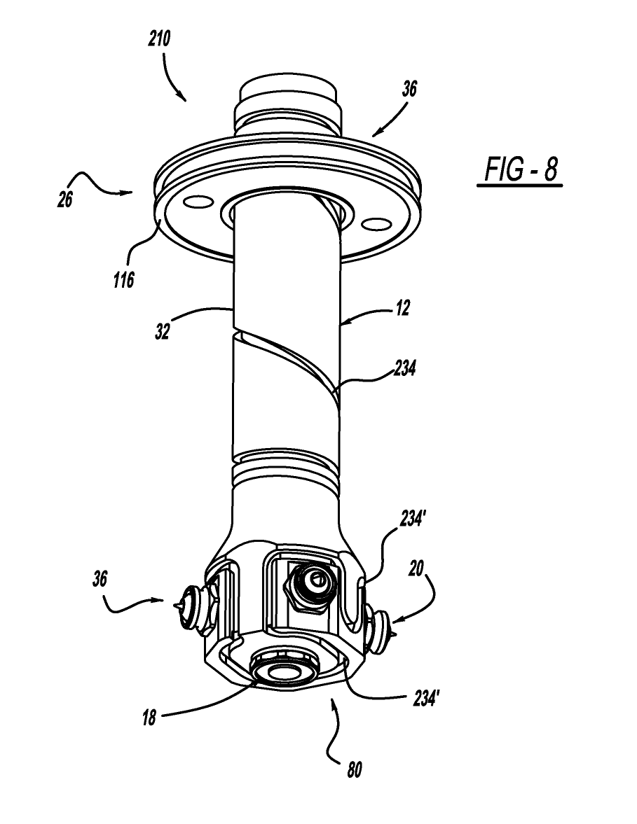

FIG. 8 illustrates an even further example of a nozzle 210. Like parts are shown having like numerals to those of FIGS. 1-4 increased by 200. In this example, the outer surface 32 defines a helically-shaped curve 234 that extends into the second section 36 into a non-conventional geometry 234′. Groove 234′ is formed in between and around the tip member 20 and further extends onto a distal face 80. In this example, a groove 234′ may be formed around the base member 18. This prevents further heat sink or loss resulting from the mounting of base 18 to a support 50 (shown in FIGS. 9-11).

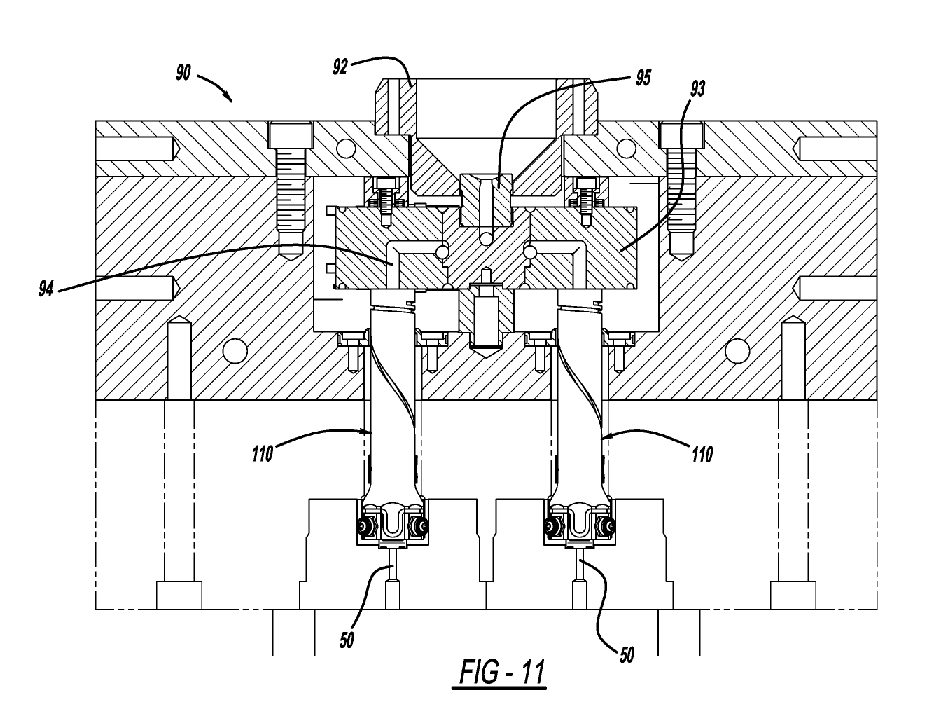

FIGS. 9-11 illustrate an example injection mold apparatus 90. Mold 90 includes a mold part cavity 91 sized and shaped according to a desired item or part. A gate 42 is defined in mold cavity that is coupled to the outlet of a nozzle 10, 110 or 210. A support 50 engages base 18 to securely fit the nozzle 10 in the mold apparatus 90. An insert tool 95 provides distribution of the molten material to the nozzle 10. The molten material flows through a distribution channel 94. In this example, a plurality of mold part cavities 91 are included in the mold apparatus 90. Each cavity is coupled to a tip member 20 of a nozzle 10. Mold apparatus 90 can further include a plurality of distribution channels 94 that are coupled to a manifold 93. A locating ring 92 can be provided to properly position the insert tool 95 in the mold apparatus 90. In FIG. 9, the nozzle 10 is positioned in the mold apparatus 90 with the heating element 14 bent upward or axially with the axis of the elongated body 12. This provides for easier insertion into mold apparatus 90 and forming necessary seals and connections of other parts associated with the process. In FIG. 10, the heating element 14 can be bent perpendicular or radially with respect to the axis of the longitudinal axis of the nozzle 10. The heating element 14 can snap into an electrical connection to provide ease in assembly. FIG. 11 illustrates a mold apparatus having multiple nozzles 110 mounted therein.

In operation, the present disclosure provides for a method of injection molding using an improved injection nozzle 10 having an elongated body member, a central passageway extending longitudinally therethrough and leading to a tip member. The nozzle includes a groove as previously described, and a heating element is positioned in the groove, such that the groove extends from the first portion 26 to the second portion 36 and is adjacent a tip member 20 to heat the first portion and second portion surrounding the tip member. The method includes the steps of dispensing molten material through the nozzle 10 into a mold part cavity 91. The temperature of the nozzle and the molten material can be maintained within a predetermined temperature range along the entire length of the elongated body member and surrounding the tip member. The temperature can be maintained from the heated first portion 26 to the heated second portion 26 of the body 12 due to the electrically insulated heating element 14 positioned within the groove.

Generally, heat sinks and heat losses can exist at the connection point of the seal of the tips with the cold mold apparatus and at the base connection with the support. Forming a groove and providing a heating element in the groove that extends along the outer surface of the nozzle as well as in between the tip members can reduce heat loss and allow for more consistent and uniform heat distribution of the molten material from inlet to outlet. This can reduce cycle time and improve efficiency since part regularity can be achieved through a more uniform temperature profile. It reduces the need to raise the temperature of the molten material above a certain threshold to ensure it stays in moldable state prior to entering the mold cavity.

The injection molding nozzle may include additional features that are generally associated with such injection molding machines, such as fittings, a controller or hydraulics or the like.

The present disclosure has been described in an illustrative manner. It is to be understood that the terminology which has been used is intended to be in the nature of words of description rather than of limitation.

What is claimed is:

1. An injection molding nozzle for dispensing of molten material comprising:
(a) an elongated body member having an outer surface, a first portion at a proximal end, a second portion at a distal end, and a central passageway extending longitudinally therethrough from the first portion to the second portion, the central passageway includes an inlet defined at the proximal end and splitting outwardly at the second portion to form a radially extending passageway leading to an outlet;
(b) a tip member coupled to the outlet to facilitate dispensing of molten material into a mold cavity;
(c) a groove defined on the outer surface of the body member that winds from the first portion to a heated section of the second portion that is positioned adjacent the tip member; and
(d) an electrically insulated heating element positioned within the groove adapted to maintain the molten material within a predetermined temperature range throughout the nozzle.

2. The nozzle of claim 1 wherein the groove defines a helical geometry leading from the first portion to the second portion and a non-helical geometry at the heated section of the second portion forming a path adjacent to the tip member.

3. The nozzle of claim 1 wherein the groove further extends around a base at a distal face of the elongated body member.

4. The nozzle of claim 1 wherein the groove defines an elongated U-shaped geometry extending from the first portion to the second portion forming a path between and adjacent to each tip member.

5. The nozzle of claim 1 wherein the apparatus includes a plurality of tip members spaced apart circumferentially around the second portion of the elongated body member.

6. The nozzle of claim 1 further comprising an insert coupled to the tip member to facilitate distribution of the molten material to the mold cavity.

7. The nozzle of claim 1 wherein the elongated body member includes a base at a distal end coupled to engage a support on a mold apparatus extending axially with respect to the elongated body member.

8. The nozzle of claim 7 wherein the base includes a threaded outer surface adapted to threadedly connect to the support of the mold apparatus.

9. The nozzle of claim 1 wherein the molten material is a polymer.

10. The nozzle of claim 1 wherein the heating element is an electrically conductive metal.

11. An injection mold apparatus comprising:
(a) a mold part cavity sized and shaped to receive molten material through a gate in the mold for receiving the molten material;
(b) a nozzle having (i) an elongated body member with an outer surface, a first portion at a proximal end, a second portion at a distal end, and a central passageway extending longitudinally therethrough from the first portion to the second portion, the central passageway includes an inlet defined at the proximal end and splitting outwardly at the second portion to form a radially extending passageway leading to a corresponding outlet, (ii) a tip member coupled to the outlet leading to the gate of the mold part cavity and adapted to facilitate dispensing of molten material into a mold part cavity, (iii) a groove defined on the outer surface of the body member that winds from the first portion to a heated section of the second portion that is positioned adjacent the tip member, and (iv) an electrically insulated heating element positioned within the groove adapted to maintain the molten material within a predetermined temperature range throughout the nozzle and the heated section of the second portion;
(c) a insert tool adapted to a deliver molten material to the nozzle; and
(d) a distribution channel formed between the insert tool and an inlet of the nozzle forming a flow path for molten material.

12. The apparatus of claim 11, further comprising a plurality of mold part cavities and a plurality of nozzles.

13. The apparatus of claim 11, further comprising a structural support element adapted to engage a support mounted on a base formed at a distal end of the nozzle to securely mount the nozzle to the apparatus.

14. The apparatus of claim 11, further comprising a manifold coupled to the insert tool and a plurality of distribution channels leading to a plurality of nozzles.

15. A method for injection molding comprising the steps of:
(a) dispensing molten material from a nozzle to a mold part cavity, the nozzle including: (i) an elongated body member having an outer surface, a first portion at a proximal end, a second portion at a distal end, and a central passageway extending longitudinally therethrough from the first portion to the second portion, the central passageway includes an inlet defined at the first portion and splitting outwardly at the second portion to form a radial passageway leading to a corresponding outlet; (ii) a tip member coupled to the outlet leading to a gate of the mold part cavity to facilitate dispensing of molten material into a mold part cavity; and (iii) a groove defined on the outer surface of the body member that winds from the first portion to a heated section of the second portion directly adjacent the tip member; and
(b) maintaining a predetermined temperature range of the molten material throughout the nozzle from the first portion to the second portion with an electrically insulated heating element positioned within the groove extending from the first portion to the second portion adjacent the tip member.
